(19) United States
(12) Patent Application Publication
(10) Pub. No.: US 2026/0116327 A1
(43) Pub. Date: Apr. 30, 2026

(54) SEAT BACK

(71) Applicant: TOYOTA BOSHOKU KABUSHIKI KAISHA, Aichi-ken (JP)

(72) Inventors: Masahiko IYODA, Nagakute-shi (JP); Hiroshi MAKI, Nissin-shi (JP); Yuji NAKANO, Nissin-shi (JP); Takeshi USHIYAMA, Toyota-shi (JP)

(73) Assignee: TOYOTA BOSHOKU KABUSHIKI KAISHA, Aichi-ken (JP)

(21) Appl. No.: 19/323,420

(22) Filed: Sep. 9, 2025

(30) Foreign Application Priority Data
Sep. 20, 2024 (JP) 2024-163553

(51) Int. Cl. B60R 21/207; B60N 2/58; B60N 2/90; B60R 21/2165

(52) U.S. Cl. CPC B60R 21/207; B60N 2002/5808; B60N 2/986

(57) ABSTRACT

A seat back includes a frame and a cushion member. The cushion member comprises a main member and two side members. The main member comprises a main pad, a main cover, and a main support member. The side member comprises a side pad, a side cover, and a side support member. At least one of the side members houses an airbag device. For side member with an airbag, its side support member has a through hole allowing the airbag device to pass through and attach to the frame. A weakened portion at the bottom of this through hole ruptures upon airbag deployment.

### CROSS-REFERENCE TO RELATED APPLICATION

This application claims priority to Japanese patent application serial number 2024-163553 filed Sep. 20, 2024, the contents of which are incorporated herein by reference in its entirety for all purposes.

### TECHNICAL FIELD

The present disclosure relates to a seat back. In particular, the present disclosure relates to a seat back with an airbag device installed inside.

### BACKGROUND

A seat back for a vehicle seat, such as an automobile, commonly features a seat back pad divided into three parts along the seat's width, which are assembled onto a seat back frame. For example, a prior art discloses a seat back having a seat back main member, which is the central portion in the seat width direction, and two seat back side members, which are located on both sides of the seat back main member. Each of these is attached to a seat back frame separately. Such a vehicle seat has good ease of assembly and is easily compatible with automation of assembly. In addition, it is easy to replace only the seat back side member, which tends to deteriorate when a seater gets on and off.

According to the vehicle seat described in the above prior art, the seat side back member often incorporates an insert wire and/or a plate for attachment to the seat back frame. This configuration makes it difficult to place an airbag device in the seat side back member, as the presence of the insert wire or the seat back frame itself could obstruct the airbag's deployment.

Therefore, there emerged a need for a seat back designed where a seat pad, covered by a seat cover and divided into three sections in the seat width direction, could be assembled to a frame. The seat back allows an attachment of an airbag device without impeding airbag's deployment.

### SUMMARY

The present disclosure relates to a seat back comprising a frame that forms a framework and a cushion member attached to the frame provides elastically support for a seat occupant. This cushion member comprises a main member at the center portion in a seat width direction and two side members, one on each side. The main member comprises a main pad, a main cover that covers the main pad, and a main support member attached to the frame for supporting the main pad. Each side member comprises a side pad, a side cover that covers the side pad, and a side support member attached to the frame-side of the side pad for supporting the side pad. At least one of the side members integrates an airbag device. The side support member housing the airbag device has a through hole, which the airbag device passes through when attached to the frame. A weakened portion is formed at the lower edge of the through hole, which is ruptured under the airbag's deployment pressure, allowing the through hole to expand laterally, thereby facilitating impeded airbag's deployment.

The side support member has a through hole and a weakened portion located at its lower edge. When the airbag deploys, its pressure ruptures the weakened portion, enabling the through hole to expand in the seat width direction. This makes it possible to attach the side member to the frame with the airbag device attached to the frame, and to place the airbag device inside the side member. As a result, the airbag can inflate forward without obstruction from the side support member during deployment. The airbag device can be attached to a separate-type seat back with the main member and each side member without reducing the functionality of the airbag system.

### BRIEF DESCRIPTION OF DRAWINGS

FIG. 1 is a perspective view of an automobile seat to which a seat back according to one embodiment is assembled.

FIG. 2 is an exploded perspective view of the seat back of FIG. 1.

FIG. 3 is a front view of the seat back of FIG. 1 showing only a right side, as the shape of the seat back is symmetrical to the right and left. A frame and a side support member of a side member are shown.

FIG. 4 is a cross-sectional view taken along a line IV-IV in FIG. 3 showing a back pad and a back cover of the side member, and a main member.

FIG. 5 is a cross-sectional view taken along a line V-V in FIG. 3 showing the back pad and the back cover of the side member, and the main member.

### DETAILED DESCRIPTION

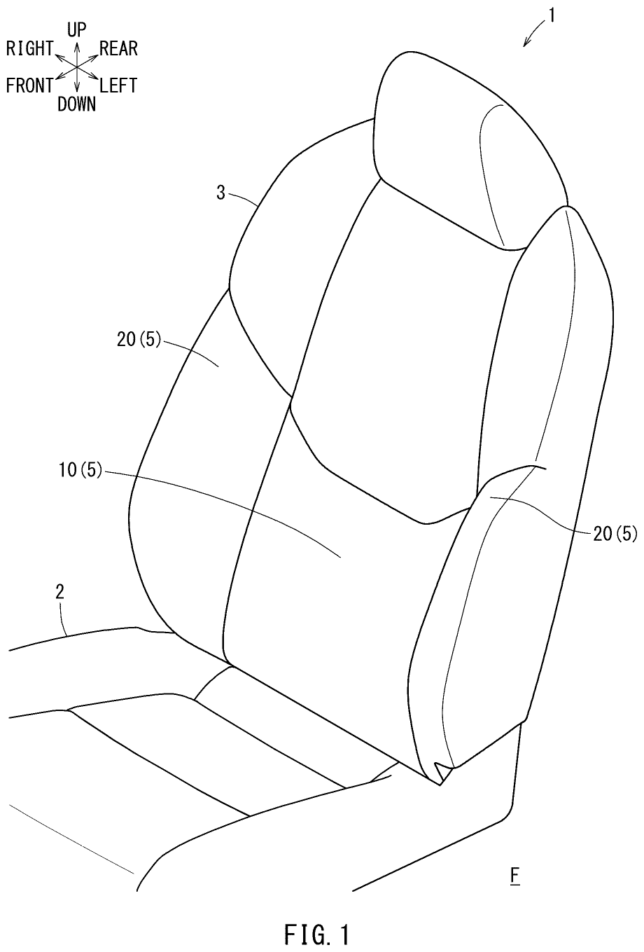

Referring to FIGS. 1 to 5, a seat back 3 of an automobile seat 1 in accordance with an embodiment of the present disclosure will be described. In the following description, explanations regarding the directions shall be based on the respective directions of up/down, front/rear, right/left as shown in each figure. Here, the up/down, front/rear, right/left directions are defined based on the automobile seat 1 when it is mounted on a floor F of the automobile. The right-left direction corresponds to a seat width direction (horizontal direction).

As shown in FIG. 1, the automobile seat 1 has a seat cushion 2 that supports the buttocks and thighs of a seater and a seat back 3 that supports the waist and back of the seater.

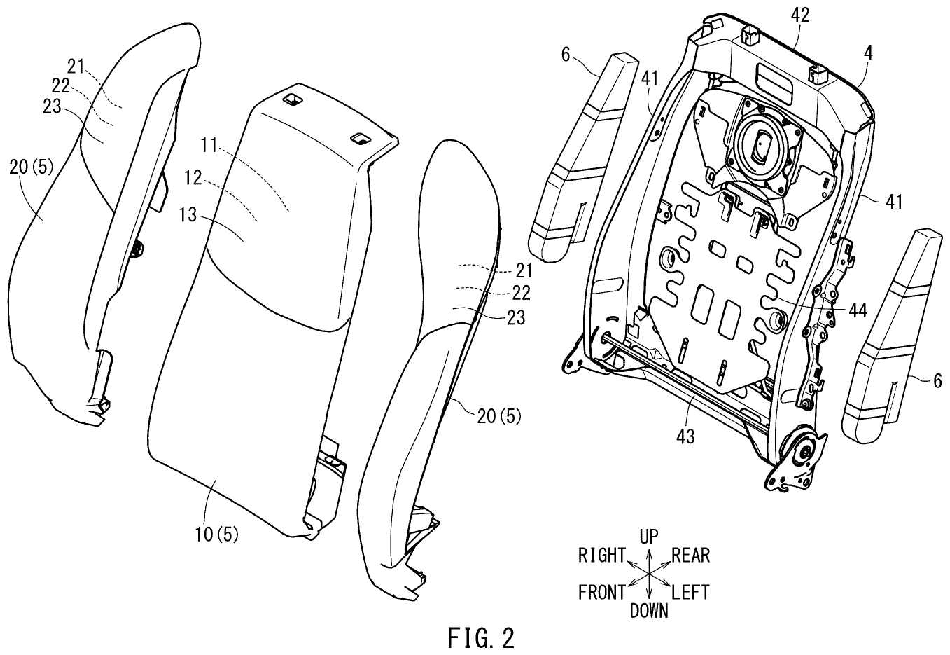

As shown in FIGS. 1 and 2, the seat back 3 has a frame 4, a cushion member 5, and a right-left pair of airbag devices 6. The frame 4 forms a framework of the seat back 3. The cushion member 5, which is assembled to the frame 4, has a cushioning function and defines the external shape of the seat back 3.

As shown in FIGS. 1 and 2, the frame 4 has a pair of side frames 41, an upper frame 42, and a lower frame 43. The side frames 41 extend vertically along the right and left sides of the seat back 3. The upper frame 42 is bridged across the upper ends of the side frames 41. The lower frame 43 is bridged across the lower ends of the side frames 41. The frame 4 is formed in the shape of a rectangular viewed from the front. A lumbar plate 44 is arranged between the upper frame 42 and the lower frame 43.

As shown in FIGS. 1 to 5, the cushion member 5 has a main member 10 at the central portion in the seat width direction and a right-left pair of side members 20 on both sides of the main member 10. The main member 10 located in the central portion of the seat back, it supports the waist and back of the seater from the rear side. The side member 20 supports the waist and back of the seater from the side.

The main member 10 has a main support member 11, a main pad 12, and a main cover 13. The main support member 11 is made of, for example, resin. The main pad 12 is a cushioning body disposed on the front side of the main support member 11 and supported by the main support member 11 against the frame 4. The main cover 13 covers the main pad 12 from the front side.

The rear surface of the upper part of the main support member 11 is fixed to the upper frame 42. The rear surface of the main support member 11 is fixed to the lumbar plate 44 at approximately the center in a vertical direction. The rear surface of the lower part of the main support member 11 is fixed to the lower frame 43.

The main pad 12 is typically made of an elastic body, often a foam molded body of polyurethane resin, which offers both cushioning and durability. The main pad 12 has approximately the same external shape as the main support member 11 when viewed from the front. The main cover 13 is formed by sewing multiple pieces. The main cover 13 is a bag-shaped that opens rearwardly. The main cover 13 covers the main pad 12, which is arranged on the front side of the main support member 11, from the front side. The end portion of the opening of the main cover 13 is then engaged with the outer peripheral part of the main support member 11, thereby the main member 10 is formed.

As shown in FIGS. 2 to 5, the side member 20 has a side support member 21, a side pad 22, and a side cover 23. The side support member 21 is made of, for example, resin. It supports the side pad 22 against the frame 4 and includes a through hole and a deforming portion with a substantially U-shaped cross section opening rearwardly. The side pad 22 is a cushioning body disposed on the front side of the side support member 21. The side pad 22 is supported by the side support member 21 against the frame 4. The side cover 23 covers the side pad 22 from the front side.

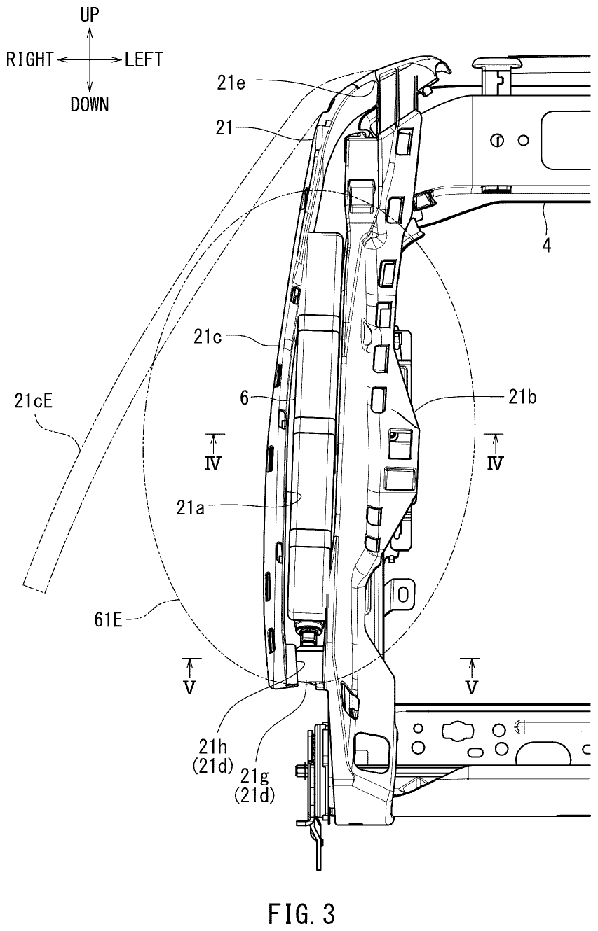

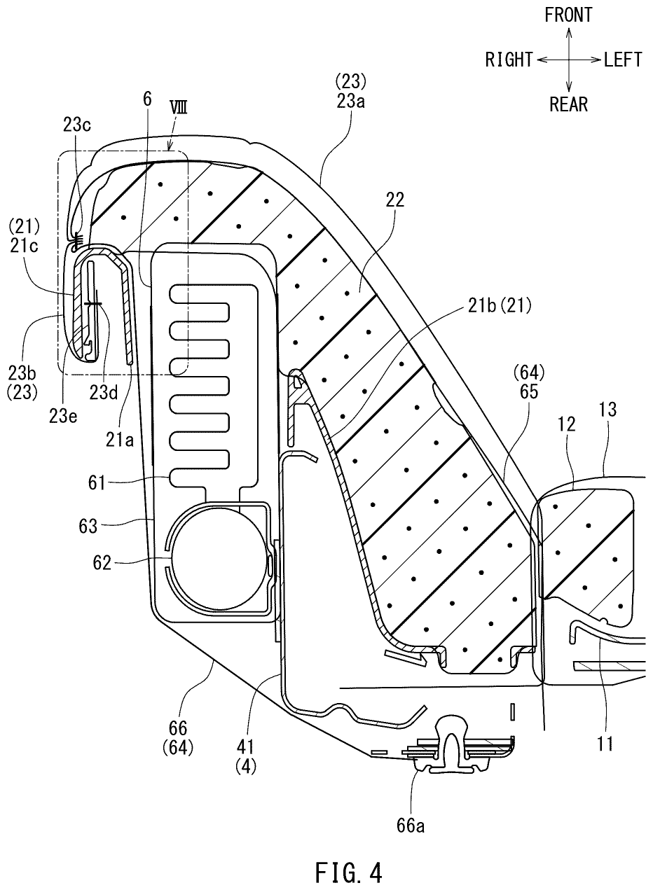

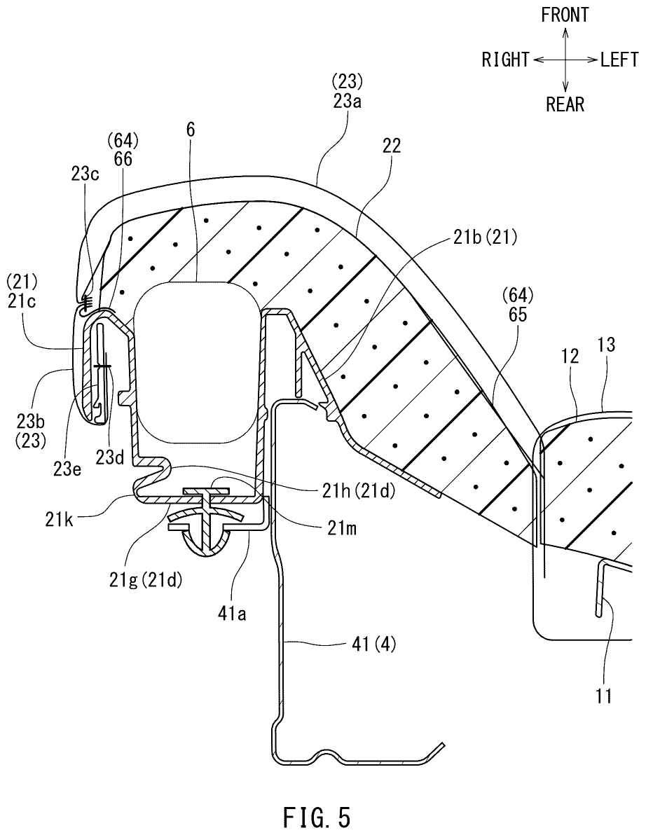

As shown in FIG. 3, the side support member 21 extends vertically. A through hole 21a is formed in the center area in a right-left direction of the side support member 21. The through hole 21a extends in the vertical direction and penetrates in a front-rear direction. The left side of the through hole 21a (inside the seat) is a base portion 21b extending vertically along the front side of the side frame 41. The right side of the through hole 21a (outside the seat) is the deforming portion 21c. The shape of the horizontal cross section of the deforming portion 21c is substantially U-shape opening rearwardly. (see FIGS. 4 and 5). A weakened portion 21d is formed at the lower part of the through hole 21a. The lower end of the base portion 21b and the lower end of the deforming portion 21c are connected via the weakened portion 21d. The upper end of the base portion 21b and the upper end of the deforming portion 21c are connected so that the upper end of the deforming portion 21c gradually curves to the left (inwardly toward the seat) as it moves upward against the upper end of the base portion 21b. On the upper part of the through hole 21a, an R-portion 21e, which has an R-shape viewed from the front, is formed between the base portion 21b and the deforming portion 21c. The rear surface (not shown) of the abbreviated center portion in the vertical direction of the base portion 21b and the weakened portion 21d are fixed to the frame 4.

As shown in FIGS. 3 and 5, the weakened portion 21d has a rectangular attaching portion 21g (when viewed from the front) and a bending portion 21h with a Z-shaped cross-section in the horizontal plane. The front end of the bending portion 21h connects to the deforming portion 21c, while the rear end of the bending portion 21h joins the right side of the attaching portion 21g. Notably, the outer bending portion 21k, which is the bending area on the seat's outer (right) of the bending portion 21h, has a thinner wall thickness. Therefore, when a load is applied to the deforming portion 21c in the rightward (outward) direction due to airbag deployment, the weakened portion 21d is easily ruptured. The attaching portion 21g is secured to a bracket 41a of the side frame 41 using a clip 21m inserted through a clip hole (not shown). It is important to note that the outer bending portion 21k directly corresponds to the “breaking area” mentioned in the claims.

FIGS. 2, 4, and 5 illustrate the side pad 22, which, from a front view, mirrors the external shape of the side support member 21. The side pad 22 is an elastic cushion body, foam molded from polyurethane resin, positioned in front of the side support member. The side pad 22 is formed to cover the front surface of the airbag device 6. The side pad 22 does not have a through hole penetrated in the front-rear direction, which corresponds to the through hole 21a. The side cover 23 is a bag-shaped formed by sewing multiple pieces, which covers the side pad 22 from the front side of the side support member 21. The opening end of the side cover 23 is then fastened to the outer peripheral part of the side support member 21, thereby the side member 20 is formed. As shown in FIG. 4, the side cover 23 has a first cover portion 23a, which covers the front and left sides of the side pad 22, and a second cover portion 23b, which covers the right side of the side support member 21. The right end of the first cover portion 23a and the right front end of the second cover portion 23b are connected by a first sewing portion 23c. The left front end of the second cover portion 23b is connected with a resin plate 23e by a second sewing portion 23d.

The airbag device 6 is assembled to the outer surface of the right and left side frames 41. Since the right and left airbag devices 6 have abbreviated symmetrical shape, the airbag device 6 on the right side will be described. As shown in FIGS. 2 to 5, the airbag device 6 is formed in a vertically long box shape. The external shape of the airbag device 6 roughly matches the shape of the through hole 21a of the side support member 21 when viewed from the front. The airbag device 6 has an airbag 61, an inflator 62, a case 63, and a stay cloth 64. Upon receiving a collision signal from the vehicle's ECU (not shown) the inflator 62 injects gas into the airbag 61. Thereby, the airbag 61 inflates to the front of the seat upon activation.

The case 63 is a vertical box-shaped container that houses the airbag 61 and the inflator 62. The left side surface of the case 63 is fixed to the side frame 41. When the airbag 61 inflates, the case 63 opens through a slit (not shown) during the airbag 61 deploys to the front of the seat.

The stay cloth 64 is a stretch-resistant guide cloth that guides the deployment direction of the airbag 61. The stay cloth 64 comprises a front stay cloth 65 arranged on the front side and a rear stay cloth 66 arranged on the rear side. The right end of the front stay cloth 65, the right end of the first cover portion 23a, the right front end of the second cover portion 23b, and the right end of the rear stay cloth 66 are overlapped in this order and sewn together at the first sewing portion 23c. The left front end of the second cover portion 23b is sewn with the resin plate 23e by the second sewing portion 23d. The resin plate 23e is arranged on the inner side of the U-shaped deforming portion 21c of the side support member 21. Thereby, the right side of the side cover 23 is fixed to the side support member 21. The left end of the front stay cloth 65 is fixed to the frame 4 by a fixing member (not shown). The left end of the rear stay cloth 66 is fixed to the frame 4 by a fixing member 66a.

The assembly procedure of the seat back 3 will be described. First, as shown in FIGS. 3 to 5, the airbag device 6 is assembled to the outer side of each side frame 41. Then, the pre-assembled right and left side members 20 are assembled to the frame 4. At this time, the airbag device 6 is arranged inside the side member 20 by passing the airbag device 6 through the through hole 21a of the side support member 21. Then, the left end of the front stay cloth 65 is fixed to the frame 4 by the fixing member (not shown). Then, the left end of the rear stay cloth 66 is fixed to the frame 4 by the fixing member 66a. Next, the main member 10 is assembled to the frame 4. Finally, a backboard (not shown) is attached to the rear side of the frame 4 to conceal inside. When removing the main member 10 and each side member 20 from the frame 4, the procedure is the reverse of the above procedure.

As shown in FIG. 1, the assembled seat back 3 is attached to the seat cushion 2 to form the automobile seat 1, which is then secured to the floor F. Upon receiving a collision signal from vehicle's ECU, the airbag device 61 activates the inflator 62 to inject gas into the airbag 61, causing it to inflate forward. During this inflation, as shown in FIG. 3, the outer bending portion 21k (see FIG. 5) of the weakened portion 21d is ruptured in the process of the airbag 61 expanding to a deployed state 61E. As a result, the deforming portion 21c of the side support member 21 turns around its upper end toward the right direction to become a deformed state 21cE. At the same time, the first sewing portion 23c is ruptured by the tensile force applied by the front stay cloth 65 and the rear stay cloth 66, in the process of the airbag 61 unfolding to become the deformed state 61E. The airbag 61 is deployed from between the first cover portion 23a and the second cover portion 23b toward the front of the seat back 3.

The described embodiments offer several advantages. The side support member 21 has the through hole 21a with a weakened portion 21d at the lower edge of the through hole 21a. The weakened portion 21d ruptures under the deployment pressure when the airbag 61 deploys, allowing the through hole 21a to expand outward in the seat width direction. The shape of the through hole 21a corresponds to the external shape of the airbag device 6 (when viewed from the front). This enables the side member 20 to be attached to the side frame 41 while the airbag device 6 is already secured to the side frame 41, effectively housing the airbag device 6 within the side member 20. Upon deployment, the airbag 61 can inflate unimpeded by the side support member 21. The airbag device 6 can be attached to a separate-type seat back 3 with a main member 10 and each side member 20 without reducing the functionality of the airbag device 6.

If the weakened portion 21d breaks at the outer bending portion 21k, a sharp edge may be formed. However, the outer bending portion 21k is formed at a position far from the airbag 61 that does not interfere with the airbag 61 during the deployment of the airbag. This reduces the risk of the airbag 61 coming into contact with the outer bending portion 21k in the process of deployment, allowing the airbag 61 to deploy without damage.

On the upper part of the through hole 21a, an R-portion 21e, which has an R-shape viewed from the front, is formed between the base portion 21b and the deforming portion 21c. Therefore, when the weakened portion 21d is destroyed during the deployment process of the airbag 61, the deforming portion 21c undergoes rotational deformation such that the lower side spreads outward in the seat width direction with the upper end as the center. At this time, the R-portion 21e acts to prevent the upper edge of the through hole 21a from being destroyed, thereby preventing the risk of parts of the side support member 21 flying off and causing injury to the body of the seater.

In addition, the weakened portion 21d is fixed to the frame 4 by a clip 21m that extends in a front-rear direction. Therefore, during the airbag deploys, the force applied to the weakened portion 21d is in the seat width direction, so there is almost no force trying to pull out the clip 21m, whose central axis extends in the front-rear direction, in the central axis direction. This makes it possible to prevent the weakened portion 21d from coming off the frame 4 and the side support member 21 from flying off.

In accordance with another aspect of the present disclosure, the weakened portion is formed at a position where the breaking area, which is broken during the deployment of the airbag, does not interfere with the airbag.

When the weakened portion breaks during the airbag deployment process, the breakage may create a sharp edge. However, the weakened portion is located in a position that does not interfere with the airbag, allowing the airbag to deploy without being damaged.

In accordance with another aspect of the present disclosure, the upper edge of the through hole in the side support member is formed in an R-shape when viewed from the front.

The weakened portion is broken during the deployment of the airbag, the lower side of the through hole expands toward the outside in the seat width direction as the airbag deploys. Since the upper edge of the through hole in the side support member is formed in an R-shape when viewed from the front, the upper edge of the through hole is not easily broken. The risk of a part of the side support members scattering and damaging the seater's body can be suppressed.

In accordance with another aspect of the present disclosure, the weakened portion is fixed to the frame by a clip or a screw whose central axis extends in a front-rear direction.

During the deployment of the airbag, the force is applied to the weakened portion is in the seat width direction. On the other hand, the central axis of the clip and screw extends in a front-rear direction. Therefore, there is almost no force in the central axis direction trying to pull out the clip or screw. This makes it possible to prevent the weakened portion from coming off the frame and the side support member from flying off.

Although certain embodiments have been described above, the present disclosure is not limited to these appearances and configuration, and various changes, additions, and deletions are possible to the extent that do not alter the gist of the invention. For example, the following are examples.

According to the above embodiments, the airbag devices 6 are arranged on both the right and left sides. However, the airbag device 6 may be arranged on only one of the right and left sides.

According to the above embodiments, the present disclosure is applied to the seat back 3 of the automobile seat 1, but may also be applied to a seat of a railway vehicle.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved seat back, and/or methods of making and using the same.

What is claimed is:

1. A seat back comprising:
a frame that forms a framework; and
a cushion member attached to the frame and configured to elastically support a seater,
wherein the cushion member further comprises
a main member located at the center portion in a seat width direction, the main member comprises a main pad, a main cover for enclosing the main pad, and a main support member attached to a frame side of the main pad for supporting the main pad, and
two side members located on both sides of the main member, each of the side members comprises a side pad, a side cover for enclosing the side pad, and a side support member attached to a frame side of the side pad and configured to support the side pad, wherein at least one of the two side members comprises an airbag device, wherein
a side support member of the at least one of the two side members has a through hole for the airbag device to pass through in a state where the airbag device is attached to the frame; and
a weakened portion located at a lower edge of the through hole, wherein the weakened portion is ruptured upon the airbag deployment, allowing the through hole to expand in the seat width direction.

2. The seat back of claim 1, wherein the weakened portion is formed at a position where the breaking area, which is ruptured during the deployment of the airbag, does not interfere with the airbag.

3. The seat back of claim 1, wherein the upper edge of the through hole in the side support member is formed in an R-shape when viewed from the front.

4. The seat back of claim 1, wherein the weakened portion is fixed to the frame by a clip or a screw whose central axis extends in a front-rear direction.

5. The seat back of claim 2, wherein the breaking area is an outer bending portion of the weakened portion.

6. The seat back of claim 3, wherein the R-shaped upper edge of the through hole is configured to prevent side support member parts from scattering and damaging the seater's body.

7. The seat back of claim 1, wherein the airbag device comprises an inflator, a case and a stay cloth.

8. The seat back of claim 7, wherein the stay cloth is a stretch-resistant guide cloth that directs the deployment of the airbag, including a front stay cloth positioned on a front side, and a rear stay cloth positioned on a rear side.
